(19) United States
(12) Patent Application Publication
(10) Pub. No.: US 2015/0247533 A1
(43) Pub. Date: Sep. 3, 2015

(54) SEALING ELEMENT FOR A ROLLING BEARING

(71) Applicant: SCHAEFFLER TECHNOLOGIES AG & CO. KG, Herzogenaurach (DE)

(72) Inventors: Thomas Fickert-Guenther, Hirschaid (DE); Andreas-Johann Bohr, Herzogenaurach (DE)

(21) Appl. No.: 14/430,098

(22) PCT Filed: Sep. 20, 2013
(86) PCT No.: PCT/DE2013/200182

§ 371 Date: Mar. 20, 2015

(30) Foreign Application Priority Data
Oct. 25, 2012 (DE) 10 2012 219 497.5

(51) Int. Cl. F16C 33/80; F16J 15/447; F16J 15/32; F16J 15/00

(52) U.S. Cl. CPC F16C 33/805; F16J 15/002; F16J 15/447; F16J 15/3216

(57) ABSTRACT

A sealing element (1) for a rolling bearing, including a central sealing ring (5) having a support ring (3), wherein on the sealing ring (7) a first resilient sealing rib (9) for forming a dynamic seal relative to an inner bearing ring section and a second resilient sealing rib for forming a static seal relative to an outer bearing ring section are formed is provided. The first resilient sealing rib and the second resilient sealing rib extend directly away from the sealing ring. A rolling bearing having a corresponding seal is also provided.

The present invention relates to a sealing element for a rolling bearing, including a central sealing ring having a support ring, on the sealing ring a first elastic sealing web being provided for forming a dynamic seal with respect to an inner bearing ring section, and a second elastic sealing web being provided for forming a static seal with respect to an outer bearing ring section.

Moreover, the present invention relates to a rolling bearing which includes a corresponding sealing element.

### BACKGROUND

Rolling bearings are frequently employed in motor vehicles, where they are used for the secure bearing of components which are movable relative to one another. A rolling bearing is generally made up of two bearing rings having integrated raceways. Rolling bearings which roll on the raceways are situated between the bearing rings. Sealing elements are customarily used to protect a rolling bearing or the bearing interior between the bearing rings from contaminants, spray water, and excessive loss of lubricating grease. The most common types of seals are so-called contactless static gap seals, in particular labyrinth seals and friction contact dynamic lip seals.

A rolling bearing which includes a sealing element of the type mentioned at the outset is known from DE 10 2005 029 036 A1. The sealing element provided therein includes a central sealing ring having a support ring. The central sealing ring is fastened at one extended end in a circumferential groove on the outer bearing ring. An elastic support part on which a first and a second sealing web are situated extends at the other end of the sealing ring. The first sealing web, as a dynamic seal, makes frictional contact against the inner bearing ring of the rolling bearing, whereas the second sealing web is designed as a static gap seal on the inner bearing ring. The first sealing web is provided directly as part of the elastic support part. The second sealing web, as a spur, extends away from the support part.

### SUMMARY OF THE INVENTION

It is an object of the present invention to provide a sealing element for a rolling bearing which allows a further improvement in the sealing effect compared to the prior art.

It is also an object of the present invention to provide a rolling bearing which includes a corresponding sealing element.

The present invention provides a sealing element for a rolling bearing, which includes a central sealing ring having a support ring, on the sealing ring a first elastic sealing web being provided for forming a dynamic seal with respect to an inner bearing ring section, and a second elastic sealing web being provided for forming a static seal with respect to an outer bearing ring section. The first elastic sealing web and the second elastic sealing web extend directly away from the sealing ring.

The present invention is based on the consideration that the lip seals and gap seals formed by contiguous sealing webs of a sealing element disadvantageously mutually influence one another, in particular at high rotational speeds. This has adverse consequences for the desired sealing effect.

However, this type of undesirable influence on the sealing components which are provided for a dynamic seal and a static seal may be prevented when the first elastic sealing web for forming a dynamic seal with respect to an inner bearing ring section, as well as the second elastic sealing web for forming a static seal with respect to an outer bearing ring section, extend directly away from the central sealing ring. In other words, both elastic sealing webs are situated directly on the sealing ring which is stabilized by the support ring, and are able to develop their sealing effect independently of one another. The second sealing web remains uninfluenced by a movement of the first sealing web caused, for example, by the centrifugal force which acts during operation of a rolling bearing. The gap seal, and in particular the radial gap of the gap seal, formed by the second sealing web remains unchanged.

In this way, due to the stated arrangement of the sealing webs on the central sealing ring, the sealing effect with respect to contaminants, entry of moisture, and loss of lubricant is improved, and the service life and the functionality of a rolling bearing are thus increased.

The support ring of the sealing element is preferably designed as a metallic reinforcement, and ensures the necessary stability of the sealing element for a rolling bearing during operation. The sealing ring itself as well as its other components are preferably composed of an elastomeric material, and are molded onto the support ring, for example. The two elastomeric sealing webs, which in the installed state are used for forming a dynamic seal and a static seal, respectively, with a section of a bearing ring in each case, extend from the sealing ring which includes the support ring.

In the installed state the first sealing web, which forms the dynamic seal, is used to seal a bearing interior, formed between two bearing rings, from moisture and dirt and also from undesirable escape of lubricant. The sealing effect of the first sealing web is achieved here in particular due to its frictional contact against an interior section of the bearing ring.

A static seal or gap seal (also referred to as a labyrinth seal) is formed by the second elastomeric sealing web. The second sealing web is designed in particular in such a way that in the installed state it overlaps in a contactless manner with the shoulder, a so-called ring caliber, provided on the external bearing ring section. The gap seal ensures that only a small amount of moisture or dirt penetrating from the outside is able to reach the friction contact seal at the inner bearing ring section. The ring caliber and the sealing web act as a labyrinth seal, and the seal gap is extended.

The first elastic sealing web is advantageously designed with a sealing base at the end. The sealing web and the sealing base are preferably manufactured as one part from an elastomeric material, in the installed state of the sealing element the sealing base making axially inwardly facing frictional contact against the sealing surface of a bearing ring. The bearing interior is thus protected from dirt and moisture, and in addition the escape of lubricant is prevented.

In one advantageous embodiment of the present invention, the sealing base includes a first lip formation which acts axially inwardly against a bearing ring section, and a second lip formation situated opposite from the first lip formation in the axial direction. The lip formations preferably have the same diameter. The first, axially inward lip formation is in particular designed as an axially inwardly facing sealing lip, and in the installed state of the sealing element makes frictional contact against the sealing surface of an inner bearing ring section, so that the necessary sealing contact is ensured in the contact area or at the contact point between the sealing lip and the sealing surface on the bearing ring. In the installed state, the second lip formation correspondingly extends axially outwardly.

In principle, of course, an embodiment of the sealing base having only one lip formation is also conceivable, this lip formation which advantageously acts axially inwardly against a bearing ring section being designed for forming the dynamic seal by frictional contact against the bearing ring. The sealing base then has a flattened design, for example, in the axial direction on its side opposite from the axially inward lip formation.

The first sealing web, in particular due to the correspondingly configured lip formations, preferably has a center of gravity S which in the direction of the first lip formation is situated at a distance a from center axis A which extends through the first sealing web. Center of gravity S is thus axially situated between the contact area of the first lip formation of the first sealing web and center axis A. In other words, in the uninstalled and/or loosely inserted state of the sealing element, center of gravity S is thus situated in the axially inwardly facing side of the first sealing web, based on center axis A.

In the installed state, in turn, center of gravity S of the first sealing web is preferably shifted by a distance a′ with respect to center axis A in the direction of the second lip formation. In other words, when the sealing element is installed, as a result of an elastic deformation of the first sealing web, center of gravity S migrates from the inner side to the outer, opposite side of center axis A. When the sealing element rotates due to the fastening to a rotating bearing ring, on account of the centrifugal force this results in a reduction of the pressing force at the contact point between the axially inwardly facing lip formation and the sealing surface on the inner bearing ring. The sealing base is pressed radially outwardly by the centrifugal force. The friction and the associated wear are thus reduced while maintaining the desired sealing functionality. This results in an increased service life of the sealing element.

Even in the case of providing the sealing base with only one lip formation and a flattened area opposite from the lip formation in the axial direction, center of gravity S of the first sealing web in the installed state is shifted with respect to center axis A by a distance a′ in the direction of the flattened area.

If the radial distance between the contact surface area of the first sealing lip of the sealing base from the bearing ring section and from the transition of the first sealing web into the sealing ring is given by a height h2, height h2 together with distance a, i.e., the axial distance between center of gravity S and center axis A in the loose state of the sealing element, preferably form a ratio 5<h2/a<100. Within this ratio, taking into account the mutual effect of the contact force on the sealing surface of the bearing ring and the centrifugal force acting on the sealing element, a sufficient sealing effect results during operation, with reduction in the tendency toward wear.

If center of gravity S is situated at a distance c from the axially inward side of the first lip formation of the sealing base, and is situated at a distance b from the axially outward side of the second lip formation of the sealing base, the ratio of b to c is preferably given by: 0.1<b/c<1. If the ratio b/c has a value between 0.1 and 1, the sealing element is designed in such a way that, even at maximum rotational speed, the first lip formation, i.e., the inwardly facing sealing lip, still rests against the contact surface area for the bearing ring.

The second sealing web preferably has an axial area section at its free end having a radial height e, and a radial area section having an axial depth d, a tear-off edge being formed at the butt edges of the axial and radial area sections. Radial height e and axial depth d preferably form a ratio of 2<e/d<0.5. In particular, liquid penetrating from the outside may drip off or be thrown out at the tear-off edge which is formed by the butt joint of the radial and axial area sections.

The transitions of the two lip formations of the first sealing web into the sealing base are preferably situated at the same height. If this height is given by h1, in one advantageous embodiment the radii of the transitions into the two lip formations differ from one another by at least 20% of the value of height h1.

In addition, the ratio of height h2 to a length L1 of the second sealing web is advantageously given by 1<h2/L1<7.

Due to the stated ratios, an optimal sealing effect is achieved in particular at high rotational speeds.

The second object of the present invention is achieved according to the present invention by a rolling bearing which includes an inner bearing ring, an outer bearing ring, and a sealing element according to one of the above-mentioned embodiments, the sealing element being fastened in a circumferential groove on one of the two bearing rings, and the first sealing web, in particular the first lip formation of the sealing base, making frictional contact against the other of the two bearing rings.

The sealing element of the rolling bearing is installed in particular between the inner bearing ring and the outer bearing ring. For fastening, the sealing element is preferably situated in a groove which encircles the outer bearing ring at the inner periphery. The elastic sealing webs extend directly away from the sealing ring in order to independently ensure the functioning of the dynamic seal which is formed by the first sealing web, and also the functioning of the gap seal which is formed by the second sealing web.

Due to the provided design, in the axial direction an essentially uniform radial gap is formed between the second sealing web and the present inner bearing ring. Since the first sealing web as well as the second sealing web extends directly away from the sealing ring, the radial gap remains essentially the same, even at high centrifugal forces, and also when center of gravity S is shifted within the first sealing web in the axial direction. The reliable functioning of the gap seal may be ensured in this way, regardless of the position of the first sealing web, and thus, independently of the dynamic sealing effect.

The rolling bearing is preferably designed as a deep groove ball bearing. Deep groove ball bearings are self-retaining bearings having numerous uses, and include solid outer rings, inner rings, and ball cages. Due to their low friction moment, the deep groove ball bearings are suited for high rotational speeds, and therefore are suited, for example, for a wide range of applications in vehicles or machines subjected to high load.

Further advantageous embodiments of the rolling bearing result from the subclaims directed to the sealing element. The advantages stated in this regard may be analogously transferred to the rolling bearing.

### BRIEF DESCRIPTION OF THE DRAWINGS

The present invention is explained in greater detail below with reference to a drawing.

FIG. 1 shows a sealing element for a rolling bearing, in a cross section;

FIG. 2 shows a detail of the sealing element according to FIG. 1, in a cross section;

FIG. 3 shows the sealing element according to FIG. 1 loosely inserted into a rolling bearing, in a cross section;

FIG. 4 shows the sealing element according to FIG. 1 fixedly installed in a rolling bearing, in a cross section; and

FIG. 5 shows another sealing element fixedly installed in a rolling bearing, in a cross section.

### DETAILED DESCRIPTION

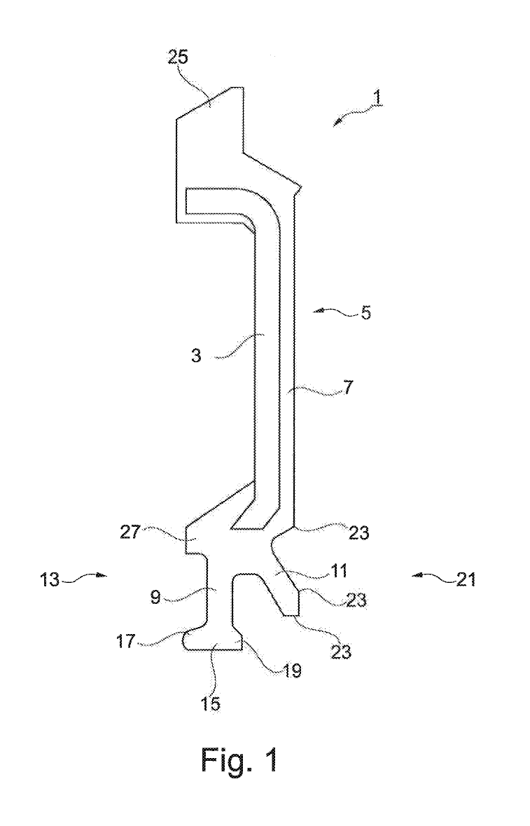

FIG. 1 shows a sealing element 1 for a rolling bearing, in a cross section. Sealing element 1 includes a support ring 3 which is designed as a metallic reinforcement. A central sealing ring 7 made of an elastomer 5 is molded onto support ring 3.

A first elastic sealing web 9 and a second elastic sealing web 11 extend from central sealing ring 7. The two sealing webs 9, 11 of sealing element 1 extend directly away from sealing ring 7. As a result of this arrangement, it may be ensured that first sealing web 9 and second sealing web 11 are able to develop their sealing effect independently of one another.

In the installed state, first sealing web 9 is used to form a dynamic seal with respect to an inner bearing ring section, not shown. For this purpose, first sealing web 9 includes a sealing base 15 at its free end 13, having two axially extending lip formations 17, 19 which have the same internal diameter. First, axially inward lip formation 17 is designed as a sealing lip, and in the installed state makes frictional contact against the sealing or contact surface area of a bearing ring section. The bearing interior is thus protected from dirt and moisture, and in addition the escape of lubricant is prevented. Second lip formation 19 is provided opposite from first lip formation 17 in the axial direction.

In the installed state, second sealing web 11 forms a labyrinth or gap seal, i.e., a static seal, with respect to an outer bearing ring section.

Free end 21 of second sealing web 11 is designed with an axial area section and a radial area section, at the butt edges of which tear-off edges 23 are provided in each case. In particular, an external liquid may drip off at tear-off edges 23, so that entry of liquid into the bearing interior may be prevented.

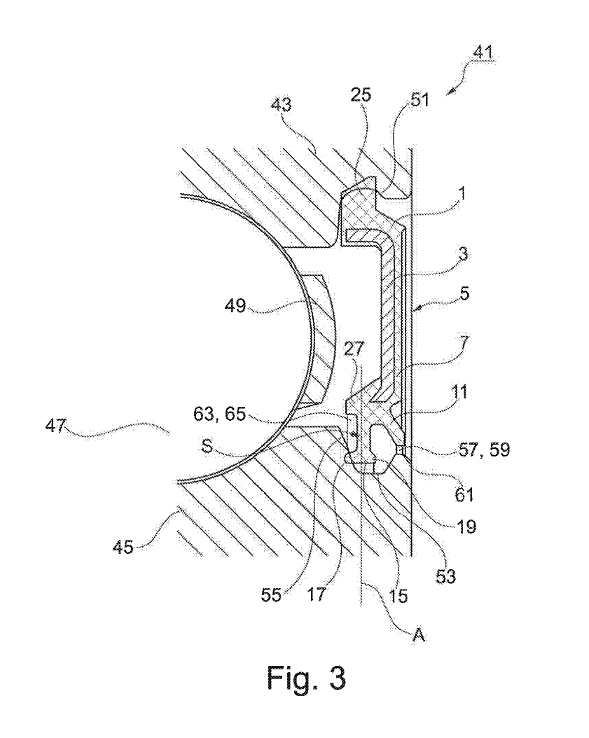

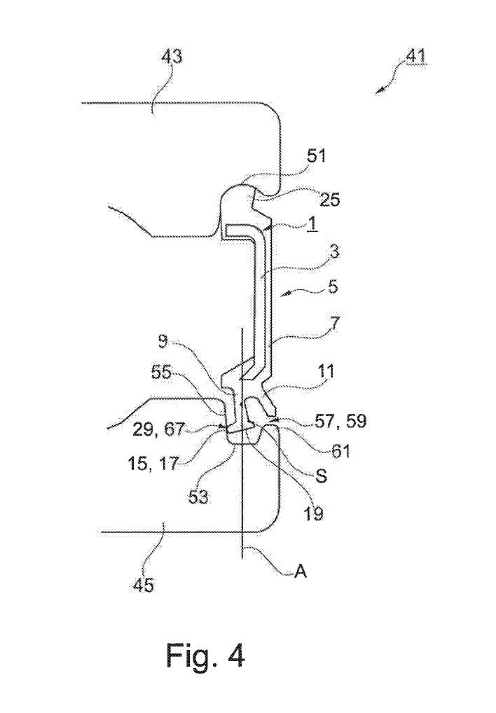

For fastening to a bearing ring, sealing element 1 also includes a circumferential lip formation 25 in the form of a bulge, which may be fixedly situated within a groove of a bearing ring. Lip formation 25 is designed as a radial extension of sealing ring 7. Furthermore, sealing element 1 is designed with an additional sealing lip 27, which in the installed state forms a further gap seal at an inner bearing ring section. For clarification of the installation situation of sealing element 1, at this point reference is made to the illustration in FIGS. 3 and 4.

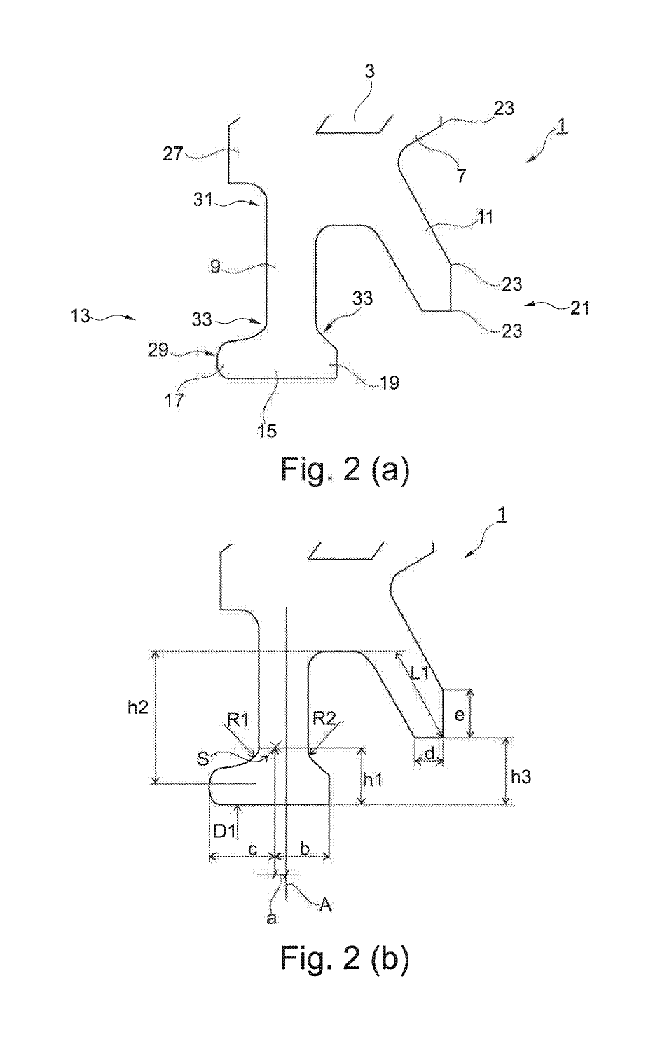

For illustrating the seal geometry, FIGS. 2(a) and 2(b) each show a corresponding detail of sealing element 1 according to FIG. 1. For reasons of clarity, only the reference numerals of the individual components are illustrated in FIG. 2(a). The geometric dimensions are shown in greater detail in FIG. 2(b).

The basic geometry of the individual components of sealing element 1, including the provided arrangement of sealing webs 9, 11, is clearly apparent with reference to FIGS. 2(a) and 2(b). First sealing web 9 and second sealing web 11 both extend directly away from sealing ring 7. The independence of sealing webs 9, 11 with respect to one another which is thus achieved prevents an undesirable influence on the sealing effect. In the installed state of sealing element 1, with its lip formation 17 designed as a sealing lip, sealing base 15 formed on first sealing web 9 may make frictional contact against a bearing ring section, and the required sealing effect may develop there. Uninfluenced by this dynamic seal, second sealing web 11 may form a gap seal with a further bearing ring section.

As is apparent from FIG. 2(b), center of gravity S is situated within first sealing web 9. In the uninstalled state of sealing element 1, not shown here, the center of gravity is shifted in the direction of first lip formation 17 of first sealing web 9 by a distance a from a center axis A which passes through first sealing web 9 in the radial direction. Center of gravity S is in particular situated axially between contact area 29 of sealing base 15 of first sealing web 9 and center axis A, so that in the uninstalled state, the center of gravity is situated in the axially inwardly facing side of first sealing web 9.

The radial distance between contact surface area 29 of first lip formation 17 and transition 31 of first sealing web 9 into support ring 7 is given by height h2. Height h2 together with axial distance a between center of gravity S and center axis A in the loose state of sealing element 1 form a ratio 5<h2/a<100. The contact force at the sealing surface of a bearing ring and the centrifugal force acting on sealing element 1 are thus ideally coordinated with one another.

In addition, it is apparent from FIG. 2(b) that first sealing web 9 as well as second sealing web 11 independently extend directly away from sealing ring 7 at height h2.

Furthermore, center of gravity S is situated at a distance c from contact surface area 29 of first lip formation 17 of sealing base 15, and is situated at a distance b from the axially outward side of second lip formation 19 of sealing base 15. The two distances b and c form the ratio 0.1<b/c<1. Taking this relationship into account, sealing element 1 is designed in such a way that in the operating state, first lip formation 17 still rests against the contact surface area of a bearing ring, even at high rotational speeds.

Tear-off edges 23 at free end 21 of the second sealing web are formed by the transition of the radial and axial area sections having axial depth d and radial height e. Tear-off edges 23 are formed at the respective butt edges. Radial height e and axial depth d are designed with a ratio of 2<e/d<0.5.

Transition 33 from sealing base 15 into first sealing web 9 is also depicted. At this transition 33, sealing web 9 widens into sealing base 15 and the two lip formations 17, 19. Transitions 33 of radii R1 and R2 of the two lip formations 17, 19, respectively, of sealing base 15 are both situated at a height h1. Radii R1 and R2 differ from one another by at least 20% of the value of height h1.

In addition, the ratio of height h2 to length L1 of second sealing web 11 is 1<h2/L1<7. In other words, in one particular specific embodiment the value of h2/L1 should be selected to be between 1 and 7.

FIG. 3 shows sealing element 1 according to FIGS. 1, 2(a), and 2(b), which is loosely inserted into a rolling bearing 41 designed as a deep groove ball bearing. Rolling bearing 41 includes an outer bearing ring 43 and an inner bearing ring 45, between which rolling bodies 47 designed as groove balls are guided in a cage 49. For positioning of sealing element 1, at outer bearing ring 43 the sealing element is inserted with its lip formation 25 in a groove 51 provided on the inner periphery of outer bearing ring 43.

First sealing web 9 is situated with its sealing base 15 in a groove 53 which encircles inner bearing ring 45. Sealing base 15, i.e., sealing lip 17, thus comes into contact with a section 55 of inner bearing ring 45 designed as a shoulder. Due to the insertion, which is still loose, of sealing element 1 between the two bearing rings 43, 45, center of gravity S of sealing base 15 of first sealing web 9 is also situated axially between contact area 29 of first sealing lip 17 with respect to inner ring section 55 and center axis A. Center of gravity S is thus situated on the axially inwardly facing side of first sealing web 9.

Second sealing web 11 forms a gap seal 57 with a radial gap 59 which extends in the axial direction. Second sealing web 11 overlaps in a contactless manner with a second shoulder 61, the so-called inner ring caliber, formed on inner bearing ring 45. Further sealing lip 27 which is formed on support body 7 forms an additional gap seal 63 with a radial gap 65 at inner bearing ring section 55.

For a detailed description of sealing element 1 and its geometry, at this point reference is made to the description for FIGS. 1, 2(a), and 2(b).

In FIG. 4, above-described sealing element 1 is fixedly installed in rolling bearing 41. Due to the fixed installation of sealing element 1, lip formation 25 of sealing element 1 in the present case is fixedly pressed into circumferential groove 51 in outer bearing ring 43. Sealing lip 17 likewise rests against shoulder 55 of inner bearing ring 45. Center of gravity S of first sealing web 9 is shifted with respect to center axis A in the direction of second lip formation 19 of sealing base 15.

In contrast to the loose insertion of sealing element 1 according to FIG. 3, center of gravity S of first sealing web 9 migrates to the side of center axis A opposite from first lip formation 17. For a rotating outer bearing ring 43, due to the effect of centrifugal force this results in a reduction in the contact force on contact surface area 29 of first lip formation 17 on sealing base 15, and on sealing surface 67 on inner bearing ring 45. The friction at contact surface area 29 may be reduced in this way.

Gap seal 57 formed by second sealing web 11 is not changed compared to the loosely inserted state of the sealing element according to FIG. 3. Radial gap 59 formed by the overlap of inner ring caliber 61 remains the same in the axial direction. It is thus clear that, even during operation of rolling bearing 41, sealing webs 9, 11, due to their arrangement on support ring 7, do not mutually influence one another, and the desired sealing effect is ensured.

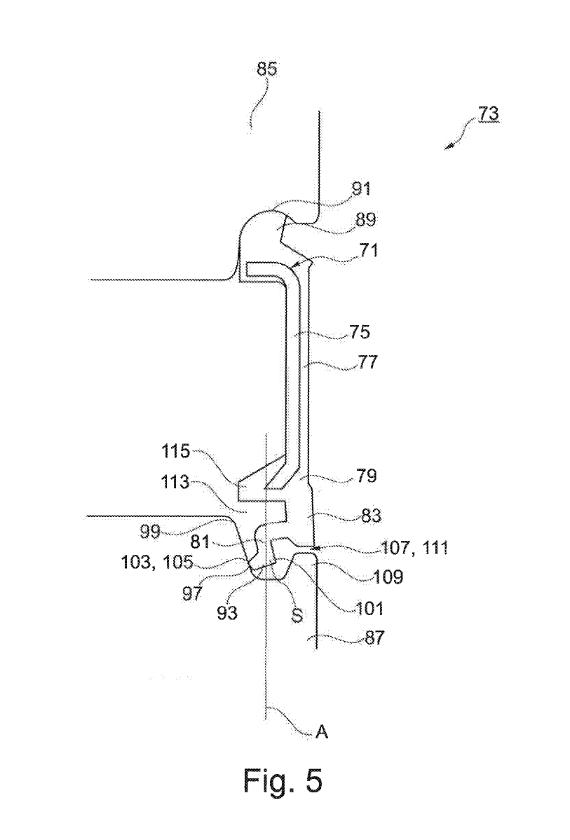

FIG. 5 shows another sealing element 71 which is fixedly installed in a rolling bearing 73. Sealing element 71 likewise includes a support ring 75 which is designed as a metallic reinforcement. An elastomeric sealing ring 77 is molded onto support ring 75. A first elastic sealing web 81 and a second elastic sealing web 83 extend directly away from elastomer 79 of sealing ring 77. This allows the two sealing webs 81, 83 to develop their sealing effect independently of one another.

Sealing element 71 is inserted between an outer bearing ring 85 and an inner bearing ring 87, and with the aid of a lip formation 89 is positioned in a groove 91 which encircles outer bearing ring 85 at its inner periphery.

The dynamic seal in the present case is likewise formed by first sealing web 81. Sealing web 81 is designed with a sealing base 93 which is situated in a groove 95 which encircles inner bearing ring 87. In contrast to sealing element 1 according to FIG. 1 through FIG. 4, in the present case, sealing base 93 of sealing element 71 includes only one lip formation 97, which acts axially inwardly against a bearing ring section 99 of inner bearing ring 87 which is designed as a shoulder. The side of sealing base 93 opposite from first lip formation 97 is designed as a flattened area 101.

Another difference is the geometry of sealing webs 81, 83. In the present case, first sealing web 81 extends at an angle away from support body 79. Second sealing web 83 has a smaller length L1 compared to sealing web 11 of sealing element 1. However, sealing web 83 also extends directly away from the support body. Sealing webs 81, 83 of sealing element 71 therefore do not mutually influence one another.

Center of gravity S of first sealing web 81 is shifted with respect to center axis A in the direction of flattened area 101 of sealing base 99, which for a rotating outer bearing ring 85 results in a reduction in the contact force between contact surface area 103 of first lip formation 97 on sealing base 99 and sealing surface 105 on shoulder 99 of inner bearing ring 87.

Gap seal 107 is formed by second sealing web 83, which in a contactless manner overlaps bearing ring section 109, designed as an inner ring caliber, at inner bearing ring 87. Radial gap 111 thus formed remains the same in the axial direction, even when sealing web 81 moves due to centrifugal forces which act on it during operation of rolling bearing 73. In other words, due to the direct arrangement of sealing webs 81, 83 on the support body, an influence on their sealing effect may be ruled out, and the sealing function of sealing element 71 may be reliably ensured.

An additional gap seal 113 is formed by a sealing lip 115, formed on the inside of support body 79, at inner bearing ring section 99.

### LIST OF REFERENCE NUMERALS

1 sealing element
3 support ring
5 elastomer
7 sealing ring
9 first sealing web
11 second sealing web
13 free end
15 sealing base
17 first lip formation
19 second lip formation
21 free end
23 tear-off edges
25 lip formation
27 sealing lip
29 contact area
31 transition
33 transition
41 rolling bearing
43 outer bearing ring
45 inner bearing ring
47 rolling bearing
49 cage
51 groove
53 groove
55 bearing ring section
57 gap seal
59 radial gap
61 bearing ring section
63 gap seal
65 radial gap
67 sealing surface
71 sealing element
73 rolling bearing
75 support ring
77 sealing ring
79 elastomer
81 first sealing web
83 second sealing web
85 outer bearing ring
87 inner bearing ring
89 lip formation
91 groove
93 sealing base
95 groove
97 first lip formation
99 bearing ring section
101 flattened area
103 contact surface area
105 sealing surface
107 gap seal
109 bearing ring section
111 radial gap
113 gap seal
115 sealing lip

1-10. (canceled)

11. A sealing element for a rolling bearing, the sealing element comprising:
a central sealing ring having a support ring, a first elastic sealing web being provided on the sealing ring for forming a dynamic seal with respect to an inner bearing ring section, and a second elastic sealing web being provided for forming a static seal with respect to an outer bearing ring section, the first elastic sealing web and the second elastic sealing web extending directly away from the sealing ring.

12. The sealing element for a rolling bearing as recited in claim 11 wherein the first elastic sealing web is designed with a sealing base at the end.

13. The sealing element for a rolling bearing as recited in claim 12 wherein the sealing base includes a first lip formation acting axially inwardly against a bearing ring section, and a second lip formation situated opposite from the first lip formation in the axial direction.

14. The sealing element for a rolling bearing as recited in claim 11 wherein the first sealing web has a center of gravity in the direction of the first lip formation situated at a distance from a center axis extending through the first sealing web.

15. The sealing element for a rolling bearing as recited in claim 14 wherein the center of gravity of the first sealing web in the installed state is shifted by a distance with respect to the center axis in the direction of the second lip formation.

16. The sealing element for a rolling bearing as recited in claim 14 wherein the center of gravity is situated at a distance (c) from the axially inward side of the first lip formation of the sealing base, and is situated at a distance (b) from the axially outward side of the second lip formation of the sealing base, the distance (b) and the distance (c) forming the following ratio: 0.1<b/c<1.

17. The sealing element for a rolling bearing as recited in claim 11 wherein the second sealing web has an axial area section at its free end having a radial height (e), and a radial area section having an axial depth (d), a tear-off edge being formed at the butt edges of the axial and radial area sections, and the radial height (e) and the axial depth (d) forming the following ratio: 2<e/d<0.5.

18. A rolling bearing comprising:
an inner bearing ring;
an outer bearing ring; and
a sealing element as recited in claim 11, the sealing element being fastened in a circumferential groove on one of the two bearing rings, and the first sealing web making frictional contact against the other of the two bearing rings.

19. The rolling bearing as recited in claim 18 wherein the first lip formation of the sealing base makes frictional contact against the other of the two bearing rings.

20. The rolling bearing as recited in claim 18 wherein a radial gap uniform in the axial direction is formed between the second sealing web and a bearing ring.

21. A deep groove ball bearing comprising the rolling bearing as recited in claim 18.
